(19) United States
(12) Patent Application Publication
(10) Pub. No.: US 2002/0016966 A1
(43) Pub. Date: Feb. 7, 2002

(54) Method and apparatus for program type searching by a receiver

(75) Inventor: Mitsunori Shirato, Iwaki-city (JP)

Correspondence Address: Brinks Hofer Gilson & Lione, P.O. Box 10395, Chicago, IL, 60610, US

(73) Assignee: Alpine Electronics, Inc.

(21) Appl. No.: 09/918,414

(22) Filed: Jul. 30, 2001

(30) Foreign Application Priority Data
Aug. 1, 2000 (JP) 2000-232958

(51) Int. Cl. H04N 5/445

(52) U.S. Cl. 725/47

(57) ABSTRACT

A receiver includes a program type information editing unit, an editing result storage unit, and a program search processing unit. A single program is associated with a plurality of program types which represent the content of that program by a program provider. The program type information editing unit sets each of the program types “valid” or “invalid” as an object to be searched for when a program search is made, and stores the set result (editing result) in the editing result storage unit. When a user specifies desired program types to command a program search, the program search processing unit refers to the editing result stored in the editing result storage unit to search for only the program types that are set “valid”, and that program types are searched through to find a desired program that is associated with the specified program types.

### BACKGROUND OF THE INVENTION

1. Field of the Invention

The present invention relates to a receiver for receiving program type information used to identify programs that a user may find enjoyable.

2. Description of the Related Art

Recently, various digital broadcasting systems use digitized video or audio signals to broadcast programs have been put into use. Examples of such digital broadcasting systems in use include the Communication Satellite (CS) digital broadcasting system and the Digital Audio Broadcasting (DAB) system for use in Europe, providing broadcast programs with high quality images and sounds.

In the various digital broadcasting systems as described above, because numerous programs may be provided, predetermined program type information is often associated with and added to program information (video signals and sound signals) for each program. This allows for categorization of program content. Hence, most receivers for receiving various digital broadcasts incorporate a search function that searches for programs belonging to a desired program type by using the program type information. The search function using the program type information allows users to specify a program type to selectively receive a program that provides the desired content from among a large number of programs.

Typically, the content of the program type information that is added to the program information is set by a program provider. However, the set content may not accurately reflect the actual content of the programs, and is sometimes different from the content users desire.

Specifically, for instance, a program A in which sports-related content is broadcast includes program type information “sports, baseball, golf” which has been set. However, there is actually little chance to broadcast the golf-related content in the program A. In this case, if a user who wants to receive programs in which the golf-related content is broadcast establishes a search condition in which “golf” is specified when a program search is performed, the program A may be found in the search results. Because the golf-related content is not substantially broadcast in the program A, and the user must eventually make another search to look for other programs in which the golf-related content is broadcast. This is time-consuming.

Therefore, conventional receivers encounter problems if the program type information set by a program provider is used because users may not efficiently select a desired program.

### SUMMARY OF THE INVENTION

Accordingly, it is an object of the present invention to provide a receiver that allows a user to efficiently select a desired program.

To this end, in one embodiment of the present invention, a receiver includes a receiving unit capable of selectively receiving one of a plurality of pieces of program information each being associated with a plurality of pieces of program type information, a program type information editing unit for designating the program type information valid or invalid, the program type information being set for each piece of program information, and an editing result storage unit for storing data on the program type information which is designated valid or invalid by the program type information editing unit. Some of the plurality of pieces of program type information which are set for each piece of program information can only be set valid or invalid.

Therefore, only program type information which a user himself considers is suitable for the searching operation can be used to select a desired program. This enables the user to efficiently select the desired program.

Preferably, the program type information editing unit designates some of the plurality of pieces of program type information invalid. When the number of program types which are set invalid is less than the number of program types which are set valid, it is only required to specify the invalid program type(s), thereby reducing the task to designate the program types valid/invalid.

Alternatively, the program type information editing unit may designate some of the plurality of pieces of program type information valid. When the number of program types which are set valid is less than the number of program types which are set invalid, it is only required to specify the invalid program type(s), thereby reducing the task to designate the program types valid/invalid.

The receiver may further include a display unit for displaying the content of the plurality of pieces of program type information which are set for each piece of program information, and an operating unit capable of individually selecting, according to the intention, the plurality of pieces of program type information displayed by the display unit. The program type information editing unit may designate the program type information which is selected by the operating unit valid or invalid. The content of a plurality of program types for each program can be displayed, thereby providing an easy review of the content. Furthermore, the program types which are designated valid or invalid can be selected while the displayed content is being viewed, thereby preventing an operation error during the selection.

Preferably, the display unit displays the program type information so as to be distinguishable between the program type information that is designated valid, and the program type information that is designated invalid by the program type information editing unit. It is therefore easy to review the program types which are set valid and invalid.

In another embodiment, the receiver may further include a program search processing unit for, when program type information to be searched for is specified, determining whether or not the program type information which is designated valid matches the program type information to be searched for, and for making a program search based on the result of the determination. The program type(s) which is designated valid can only be used for a program search, and only the necessary program type information can be thus used out of the program type information that is given by a program provider without the undesired information being eliminated, thereby efficiently performing a program search.

In yet another embodiment, the plurality of pieces of program type information include first program type information which is provided by a program provider, and second program type information which is optionally added by a user. The second program type information can be optionally added by a user, thereby making it possible to reliably search for the desired program of the user.

In yet another embodiment, the program search processing unit searches for programs in which the second program type information is valid and in which the first program type information that is valid and includes the program type information to be searched for. The second program type information is first used to select programs, and the first program type information is then used for a further program search, thereby making it possible to efficiently search for a desired program that satisfies a complicated condition.

### BRIEF DESCRIPTION OF THE DRAWINGS

FIG. 1 is a block diagram of a receiver according to an embodiment of the present invention.

FIG. 2 is a view of an example data structure of program data for use with an embodiment of the present invention.

FIG. 3 is a table showing a relationship between program information and program type information.

FIG. 4 is a flowchart of the operation procedure of the receiver to edit the set content of the program type information according to an embodiment of the present invention.

FIGS. 5A and 5B are views of example displays of the program type information according to an embodiment of the present invention.

FIG. 6 is a table of an example of the editing results of the program type information stored in an editing result storage unit according to an embodiment of the present invention.

FIG. 7 is a flowchart of the operation procedure of the receiver to search for a desired program using the program type information according to an embodiment of the present invention.

FIG. 8 is a view of an example display of the program search results according to an embodiment of the present invention.

### DETAILED DESCRIPTION OF THE INVENTION

A receiver according to one embodiment of the present invention is described with reference to the drawings.

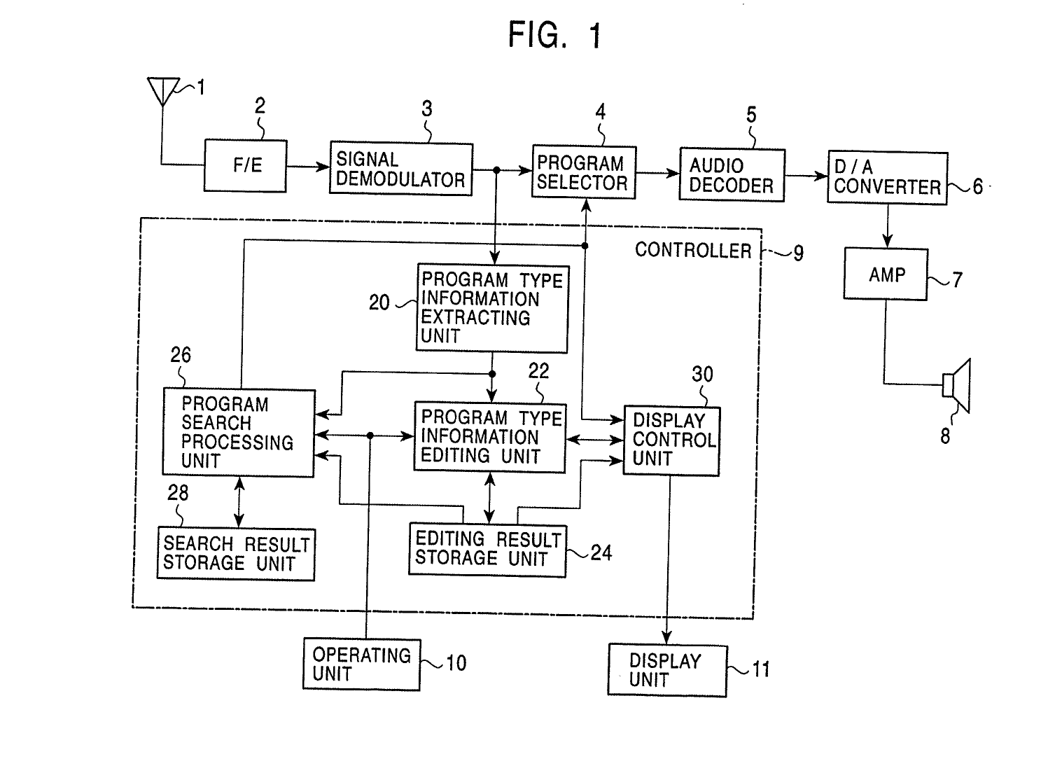

FIG. 1 is a block diagram of a receiver according to one embodiment of the present invention. The receiver receives audio broadcast signals, and includes an antenna 1, a front end unit (F/E) 2, a signal demodulator 3, a program selector 4, an audio decoder 5, a digital-to-analog converter (D/A converter) 6, an amplifier 7, a speaker 8, a controller 9, an operating unit 10, and a display unit 11.

The front end unit 2 extracts a desired receiving frequency (tuning frequency) component from the signal received via the antenna 1, and outputs an intermediate frequency signal which is obtained by converting the frequency of the extracted signal.

The signal demodulator 3 performs a predetermined demodulation process after the intermediate frequency signal output from the front end unit 2 is converted into digital data, thereby demodulating the interleaved transmission data.

The program selector 4 deinterleaves the transmission data output from the signal demodulator 3, which is recovered into the original data stream before being subjected to a predetermined error detection and correction process to restore the program data containing program information (audio data) for a plurality of programs. In response to a command from the controller 9, the program selector 4 extracts and outputs program information corresponding to one program selected by a user.

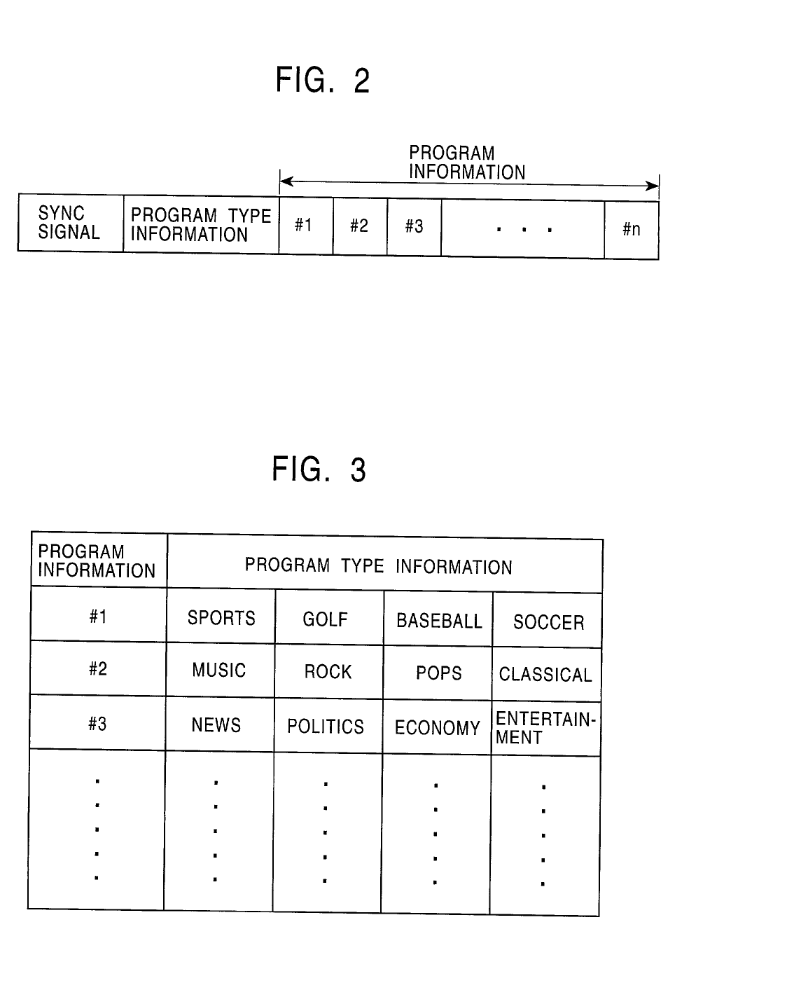

FIG. 2 shows an example data structure of the program data for use with an embodiment of the present invention. Here, a plurality of programs are multiplexed in a single broadcast signal, which is transmitted in a predetermined frame unit. The signal contains (1) a synchronization signal, (2) program type information, and (3) program information. The synchronization signal may be used to recognize the beginning of the frame. The program information corresponds to audio data of the programs, and includes a plurality of pieces of program information #1, #2, #3, . . . , and #n corresponding to the plurality of programs. As shown in FIG. 2, the program information is implemented as audio data that is compressed according a predetermined compression method such as the MPEG 1 Audio Layer II. The program type information represents the general content of the programs, or program types, and a plurality of pieces of program type information, or program type identifiers, are associated with a piece of the program information, or program information segments.

FIG. 3 is a table showing a relationship between the program information and the program type information. As shown in FIG. 3, for example, if a program 1 has sports-related content mainly concerning golf, baseball, and soccer, the program information #1 corresponding to the program 1 is associated with four program types “sports”, “golf”, “baseball”, and “soccer”. If a program 2 has music-related content mainly concerning rock music, pop music, and classical music, the program information #2 corresponding to the program 2 is associated with a plurality of program types such as “music”, “rock”, “pops”, and “classical”. Likewise, other programs are further associated with a plurality of program types.

However, where the program types are set by a program provider, as previously described, the program type may not exactly reflect the actual content of the programs.

The data structure of the program data shown in FIG. 2 is only for illustration, and the present invention is not limited thereto. A variety of data structures may be contemplated for the convenience of the broadcast form of programs without departing from the spirit and scope of the invention, namely, in the form where the program signal is transmitted so that a plurality of pieces of program type information may be associated with a single piece of program information. Also, in the relationship between the program information and the program type information shown in FIG. 3, the number of pieces of program type information to be added to a single piece of program information is not limited to four.

Referring back to FIG. 1, the audio decoder 5 performs a predetermined expansion process on the program information output from the program selector 4, and outputs PCM (pulse code modulation) audio data. The digital-to-analog converter 6 converts the PCM audio data output from the audio decoder 5 into an analog signal, and outputs the signal.

The amplifier 7 amplifies the analog signal output from the digital-to-analog converter 6 with a predetermined gain, and outputs the result to the speaker 8. The speaker 8 outputs sound corresponding to the amplified analog signal. The controller 9 controls the overall operation of the receiver according to an embodiment of the present invention and is described in detail below.

The operating unit 10 includes various operation keys for allowing a user to perform various operations such as to switch programs and to edit the program type information, and outputs a signal according to the operating state of the operation keys to the controller 9. The display unit 11 displays program titles or program types that the currently received program is identified with, or the operating state of the operating unit 10 by the user.

The controller 9 includes a program type information extracting unit 20, a program type information editing unit 22, an editing result storage unit 24, a program search processing unit 26, a search result storage unit 28, and a display control unit 30.

The program type information extracting unit 20 extracts the program type information from the program data output from the signal demodulator 3.

The program type information editing unit 22 edits the program type information associated for each program according to a command given by the user. Specifically, according to one embodiment of the present invention, in response to the command from the user, the program type information is edited according to the intention of the user, regardless of the setting by a program provider. Here, the program types are each associated with a program type validity designation as an object to be searched for when a program search is made. In the presently preferred embodiment, the program type validity designations comprise data strings representing validity and invalidity settings. In other embodiments, the program type validity designations may be referred to as “desirable” and “not desirable settings”, “good” and “bad” settings, or “searchable” and “non-searchable” settings. Further, in yet other embodiments, the program type designations may comprise more than two settings.

This editing operation is performed by the program type information editing unit 22. For example, in the above-noted program 1 in FIG. 3, in which the four program types “sports”, “golf”, “baseball”, and “soccer” are associated with the program information #1, the set content of the program type information can be edited according to a command from a user such that “sports” and “baseball” may be set valid and “golf” and “soccer” may be set invalid.

Furthermore, according to an embodiment of the present invention, besides the process of editing the program type information set by a program provider for each program, there is further provided program type information for each program that can be optionally set by a user. The editing process of the set content of the program type information that can be optionally set is also performed by the program type information editing unit 22. Specifically, the program type information that can be optionally set by a user may be embodied as a program type “favorite”, such that “favorite” can be set valid or invalid according to the intention of a user. For example, with respect to a program of which the content is a favorite, that program includes the program type “favorite” which is set valid. If a search condition such as ‘programs of which “favorite” is set valid’ is established when a program search is performed, a program search can be made so that the user's favorite programs may be extracted by priority.

The editing result storage unit 24 stores the editing result of the program type information from the program type information editing unit 22. A specific example of the editing results stored in the editing result storage unit 24 is described later.

When a search condition is established and a predetermined search command is given by a user, the program search processing unit 26 searches for programs that satisfy the established search condition. Specifically, in one embodiment of the present invention, there are four program types associated for each program by a program provider, and the additional program type “favorite” that can be optionally set by the user for each program. Then, the program types are each set valid or invalid by the user as an object to be searched for when a program search is made. Therefore, in response to a predetermined program search command, the program search processing unit 26 fetches the program type information from the program type information extracting unit 20, and refers to the editing result of the program type information stored in the editing result storage unit 24 to search for a program that satisfies the search condition established by the user. The search result storage unit 28 stores the program search result by the program search processing unit 26.

The display control unit 30 controls the display various views on the display unit 11, including an editing view of the program type information and a program search result view. For example, when the set content of the program type information is edited, the display control unit 30 performs a display control on each of the program types to be edited such that the program types that are currently set “valid” are displayed with predetermined emphasis and the program types that are currently set “invalid” are displayed in a normal mode with no emphasis. A specific example view displayed on the display unit 11 according to the display control performed by the display control unit 30 is described later.

The antenna 1, the front end unit 2, the signal demodulator 3, the program selector 4, and the controller 9 comprise a receiving means. The program type information editing unit 22 corresponds to a program type information editing means, and the editing result storage unit 24 corresponds to an editing result storage means. The display unit 11 and the display control unit 30 correspond to a display means. The operating unit 10 corresponds to a selecting means, and the program search processing unit 26 corresponds to a program search means.

The operation of the receiver having such a structure according an embodiment of the present invention will now be described.

(1) Procedure of editing the set content of the program type information

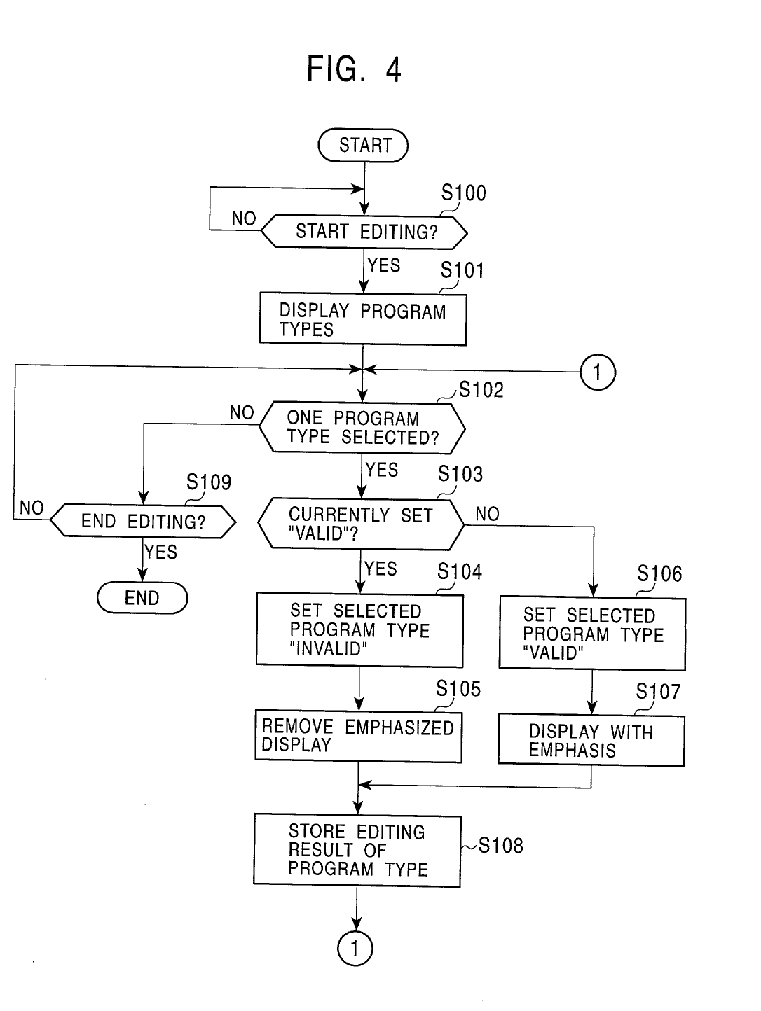

FIG. 4 is a flowchart of the operation procedure of the receiver to edit the set content of the program type information, specifically showing the operation that is substantially performed by the program type information editing unit 22. The description is made in conjunction with an example in which the above-noted program 1 is received.

The program type information editing unit 22 determines in act S100 whether a command to start editing the set content of the program type information has been entered by the operation of the operating unit 10. If starting of the editing operation has been ordered, i.e., YES is obtained, the program type information editing unit 22 sends a command to the display control unit 30 to display program types that are associated with the currently received program.

In response, the display control unit 30 fetches, from the program type information extracting unit 20, the program types that are associated with the program information corresponding to the program which is currently received, and refers to the editing result of the program type information that has been previously stored in the editing result storage unit 24 to display the program types on the display unit 11 so that the program types that are set “valid” are displayed with predetermined emphasis (act S101). A specific example display is described later.

In act S102, the program type information editing unit 22 determines whether any one of the program types has been selected by the operation of the operating unit 10. If any program type has been selected, i.e., YES is obtained in act S102, the program type information editing unit 22 refers to the editing result that has been previously stored in the editing result storage unit 24, and determines whether the selected program type is set “valid” (act S103).

If it is set “valid”, i.e., YES is obtained in act S103, the program type information editing unit 22 sets the selected program type “invalid” (act S104). In act S105, the display control unit 30 removes an emphasized display of the program type that is set “invalid” in act S104.

If the selected program type is not set “valid”, or is set “invalid”, i.e., NO is obtained in act S103, the program type information editing unit 22 sets the selected program type “valid” (act S106). In act S107, the display control unit 30 allows an emphasized display to be applied to the program type which is set “valid” in act S106.

After the processing in act S105 or S107, the program type information editing unit 22 stores the editing result of the program type information in the editing result storage unit 24 (act S108), and then returns to act S102 to iterate the processing after the act of determining whether one program type has been selected.

If one program type has not been selected, i.e., NO is obtained in act S102, the program type information editing unit 22 determines in act S109 whether a command to end editing the program type information has been entered by the operation of the operating unit 10. If ending of the editing operation has not been ordered, the program type information editing unit 22 returns to act S102 to iterate the same processing until the command to end the editing has been entered. If the command to end the editing has been entered in act S109, the program type information editing unit 22 ends the series of editing acts.

Furthermore, in the editing process of the program type information, the program type information editing unit 22 may set all of the plurality of program types “valid” at the initial state, some of which may be designated invalid. When the number of program types which are desired to be set “invalid” is less than the number of program types which are desired to be set “valid”, it is only required to specify the invalid program type(s), thereby reducing the task to designate the program types valid/invalid.

Alternatively, the program type information editing unit 22 may set all of the plurality of program types “invalid” at the initial state, some of which is designated valid. When the number of program types that are desired to be set “valid” is less than the number of program types that are desired to be set “invalid”, it is required to specify the valid program type(s), thereby reducing the task to designate the program types valid/invalid.

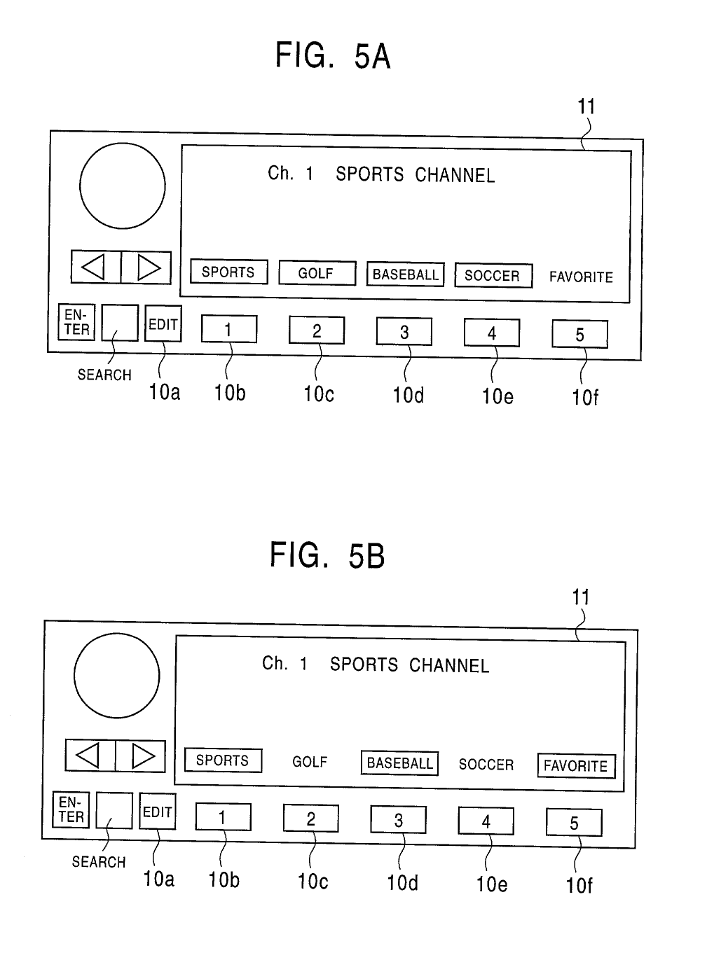

FIGS. 5A and 5B are views of example displays of the program type information. As shown in FIGS. 5A and 5B, the receiver includes the operating unit 10 having various operation keys 10a to 10f, and the display unit 11 on a front surface of the receiver. The display unit 11 presents the program title “SPORTS CHANNEL” of the program 1 (Ch. 1) on an upper portion of the display, and program types that are associated with the program 1 on an lower portion of the display screen. The program types that are set “valid” are displayed with emphasis such that they are enclosed with frames as indicated, while the program types that are set “invalid” are indicated with only character strings. For example, as shown in FIG. 5A, out of five program types which are associated with the program 1, “sports”, “golf”, “baseball”, and “soccer” are set “valid”, and “favorite” is set “invalid” immediately after the editing process starts, and “sports”, “golf”, “baseball”, and “soccer” are enclosed with frames as indicated, and “favorite” is indicated with only character strings.

The operation key 10a is used to enter a command to start and stop editing the program type information. The operation key 10a is pressed for a predetermined time, for example, several seconds, to command the start and stop of editing. The five operation keys 10b to 10f correspond to the five program types presented on the display unit 11 in a one-to-one relation such that any one of the operation keys 10b to 10f can be pressed to select a program type to be edited. In the illustration of FIGS. 5A and 5B, the program types “sports”, “golf”, “baseball”, “soccer”, and “favorite” correspond to the operation keys 10b, 10c, 10d, 10e, and 10f, respectively.

According to the procedure shown in FIG. 4 as described above, for example, out of five program types which are associated with the program 1, “sports”, “baseball”, and “favorite” are set “valid”, and “golf” and “soccer” are set “invalid”, and “sports”, “baseball”, and “favorite” are enclosed with frames as indicated, while an emphasized display is removed from “golf” and “soccer” which are indicated with only character strings, as shown in FIG. 5B. In this way, the display state (whether or not an emphasized display is applied) varies depending upon whether the set content of the program type information is “valid” or “invalid”. This makes it possible to visually identify the set content of the program type information.

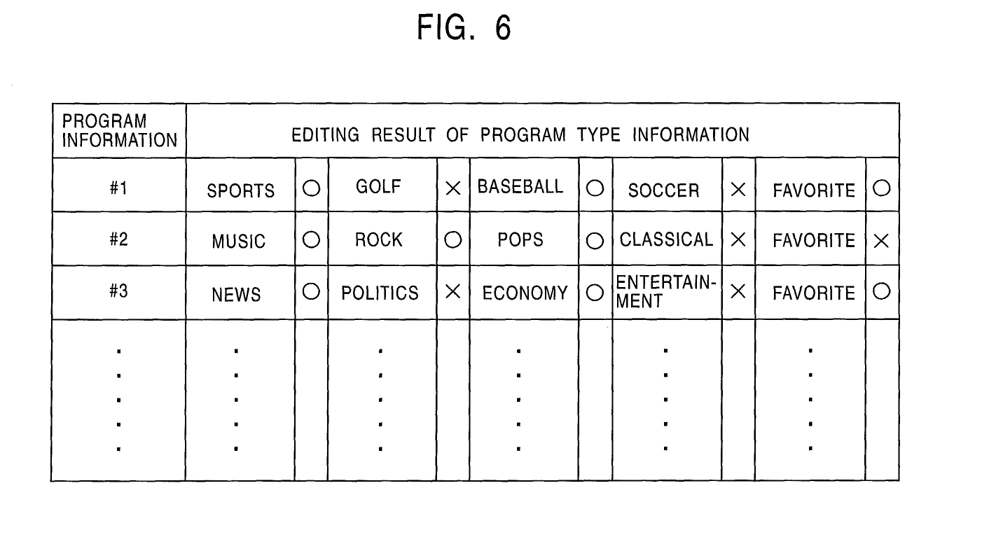

FIG. 6 is a table showing an example of the editing results of the program type information stored in the editing result storage unit 24. In FIG. 6, the program types marked with “O” are “valid”, and the program types marked with “X” are “invalid”. For example, with respect to the program 1 associated with five program types, the editing result where “sports”, “baseball”, and “favorite” are set “valid”, and “golf” and “soccer” are set “invalid” is stored. With the program 2 associated with five program types, the editing result where “music”, “rock”, and “pops” are set “valid”, and “classical” and “favorite” are set “invalid” is stored.

(2) Procedure of a program search using the program type information

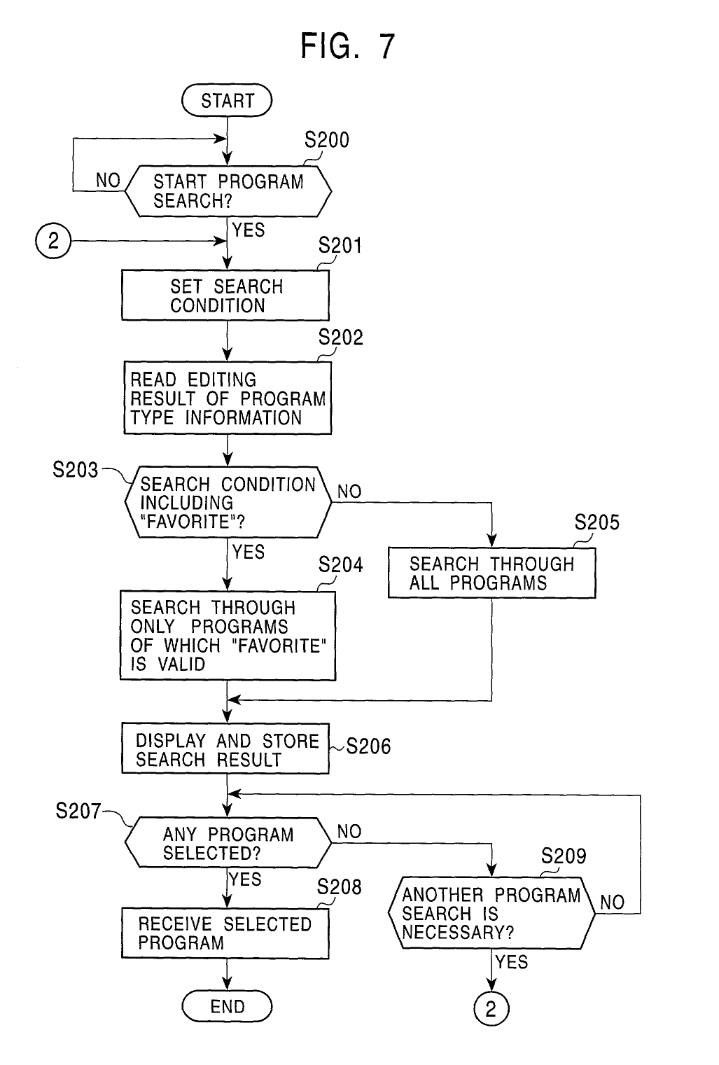

FIG. 7 is a flowchart of the operation procedure of the receiver to search for a desired program using the program type information, specifically showing the operation which is substantially performed by the program search processing unit 26.

First, the program search processing unit 26 determines in act S200 whether a command to start a program search has been entered by the operation of the operating unit 10. If starting of the program search has been ordered, i.e., YES is obtained, a search condition is set according to it a command from a user (act S201).

Specifically, program types to be searched for are specified to establish a search condition. For example, if a live broadcast of baseball is desired to be received, the program type “baseball” is specified, thereby searching for a program that is associated with “baseball” as the program type information. Furthermore, in one embodiment of the present invention, the program type “favorite” is specified, so that the programs that are associated with “favorite” are only searched for when a program search is made. A combination of the program type “favorite” and any other program type may also be specified. For example, if a search condition is established in which “baseball” and “favorite” are specified, the system first searches for programs that are associated only with “favorite” and then searches through to find programs that are associated with “baseball”.

After the search condition has been established, the program search processing unit 26 reads the editing result of the program type information stored in the editing result storage unit 24 (act S202). Then, the program search processing unit 26 determines in act S203 whether the search condition established by a user contains “favorite”.

If the search condition contains “favorite”, i.e., YES is obtained in act S203, the program search processing unit 26 refers to the search result of the program type information read in act S202 as described above, so that only the programs of which the program type “favorite” is set “valid” are searched. Then, these programs are searched through to find programs that still satisfy the search condition (act S204). If a search condition is established in which “favorite” is only specified in act S201 as described above, i.e., no other search condition is specified, the programs of which the program type “favorite” is set “valid” are all extracted in act S204.

If the search condition does not contain “favorite”, i.e., NO is obtained in act S204, the program search processing unit 26 refers to the editing result of the program type information to search all programs for programs that satisfy the search condition (act S205).

Accordingly, in the program search process in act S204 or S205, the editing result of the program type information is referred to, so that the program type information that is set “invalid” is not searched for. Consider an example in which a search condition is established in which the program type “golf” is specified. If the program type information set by a program provider is utilized, program I may be extracted as satisfying the search condition. However, if the program type “golf” which is associated with the program 1 is set “invalid”, as shown in FIG. 6, program 1 is not searched for, and is not extracted as satisfying the search condition.

Once the program search result that meets the search condition is acquired, the program search processing unit 26 stores the search result in the search result storage unit 28, and sends a command to the display control unit 30 to display the search result on the display unit 11 (act S206).

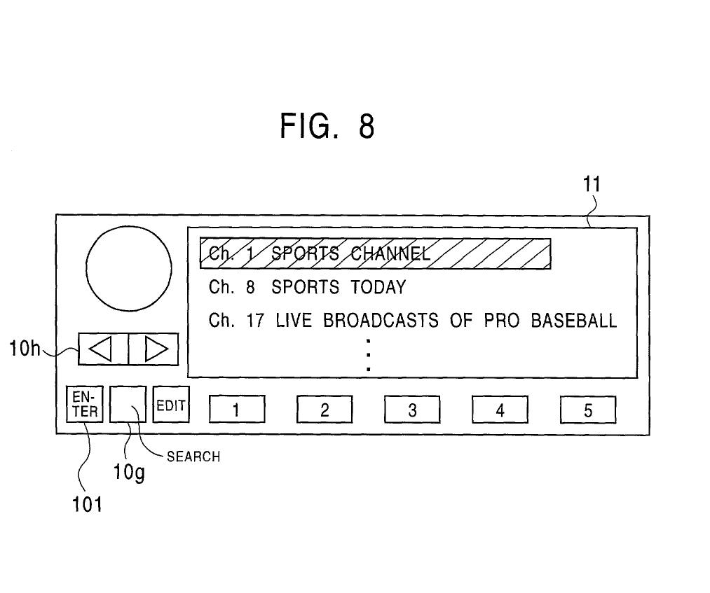

FIG. 8 is a view of an example display of the program search result.

As shown in FIG. 8, the search result includes a list of program numbers such as “Ch. 1” and program titles such as “SPORTS CHANNEL”. It is noted that the program I described above is expressed as “Ch. 1 SPORTS CHANNEL”. In the illustrated embodiment, programs of which the program type “favorite” is set “valid” are presented on the top of the list by priority.

The operation key 10g is used to enter a command to start and stop a program search. For example, the operation key 10g is pressed for a predetermined time, for example, several seconds, to command the start and stop of a program search. An operation key 10h is used to move the cursor up and down for the inverse highlighting (or hatch in FIG. 8) of a program number and title. If the search result list is not completed within the screen, the operation key 10h is used to move the cursor up and down for the inverse highlighting, so that the list may be scrolled. This scroll is performed by the display control unit 30 based on the search result stored in the search result storage unit 28. An operation key 10i is used to enter a command to determine which program in the search result is desired to be received.

After the search result is presented, the program search processing unit 26 determines in act S207 whether any program has been selected by a user. Specifically, the operation key 10h is operated so that a desired program can be inverse highlighted, and the operation key 10i is pressed in this state, thereby selecting the desired program.

Once the desired program has been selected, in act S208, the program search processing unit 26 sends a command to the program selector 4 to receive the selected program. Specifically, the program search processing unit 26 notifies the program selector 4 of the selected program, and the program information corresponding to the selected program is extracted from the program data by the program selector 4, which is subjected to a predetermined expansion process by the audio decoder 5.

If a program has not been selected, i.e., NO is obtained in act S207, the program search processing unit 26 determines in act S209 whether a command to make another program search has been entered. For example, when the operation key 10g is pressed while the search result is being presented, another program search is ordered. If another program search is not ordered, i.e., NO is obtained in act S209, the program search processing unit 26 loops back to iterate the processing after the determination act S207.

If another program search has been ordered, i.e., YES is obtained in act S209, the program search processing unit 26 returns to act S201 to iterate the processing after search condition setting.

In the receiver according to the illustrated embodiment, a plurality of program types that are associated for each program are each set valid or invalid as an object to be searched for when a program search is performed, so that the set content can be edited according to the intention of a user, regardless of the setting by a program provider. Thus, program types that the user considers are suitable for the searching operation can only be used for a program search. Therefore, the user can efficiently select the desired program. In particular, the receiver according to the illustrated embodiment provides program types that are set and sent by a program provider for each program, as well as the program type “favorite” that can be optionally set for each program by a user such that “favorite” may be set valid or invalid according to the intention of the user. Therefore, if a search condition such as ‘programs of which “favorite” is valid’ is established for a program search, the user can make a program search so as to extract his favorite programs by priority, thereby making it possible to more reliably select the desired program.

The present invention is not limited to the illustrated embodiment, but a variety of modifications may be made without departing from the spirit and scope of the invention. For example, while a broadcast signal is digitized before being transmitted in the illustrated embodiment, the present invention may be applied to a receiver that receives various broadcast signals in the form without departing from the spirit and scope of the invention, namely, in the form where a plurality of pieces of program type information are associated with a single piece of program information.

Accordingly, the present invention may be applied to receivers, such as an FM multiplex broadcast receiver, by which an audio signal is transmitted as an analog signal and predetermined additional information including program type information is digitized and multiplexed before being transmitted. Although an audio broadcast receiver has been described by way of example in the illustrated embodiment, the present invention is not limited thereto, but may also be applied to receivers which receive various broadcasts such as the BS digital broadcast and the CS digital broadcast containing video images. In this case, a player system for video signals may be involved in a receiver in addition to a player system for audio signals.

The broadcast signal communication is not limited to wireless systems using radio waves and may also include the use of wired systems.

According to the present invention, therefore, some of a plurality of pieces of program type information that are set for each piece of program information can only be set valid or invalid. Therefore, program type information which a user himself considers is suitable for the searching operation can only be used to select a desired program. This enables the user to efficiently select the desired program.

1. A receiver comprising:
a receiving unit operable to receive a plurality of program information segments, each of said plurality of program information segments being associated with a plurality of program type identifiers;
a program type information editing unit in communication with said receiving unit and operable to designate at least one of said plurality of program type identifiers invalid; and
an editing result storage unit in communication with said receiving unit and operable to identify program type identifiers that have been designated invalid by said program type information editing unit.

2. The receiver of claim 1 wherein said receiving unit comprises:
an antenna;
a front end unit in communication with said antenna;
a signal demodulator in communication with said front end unit;
a program selector in communication with said signal demodulator;
an audio decoder in communication with said program selector;
a digital to audio converter in communication with said audio decoder;
an amplifier in communication with said digital to audio converter; and
a speaker in communication with said amplifier.

3. The receiver of claim 1 further comprising:
a display unit in communication with said receiving unit and operable to display said at least one of said program type identifiers; and
an operating unit in communication with said receiving unit and operable to select program type identifiers displayed by said display unit,
wherein said program type information editing unit designates the program type identifier selected by said operating unit invalid.

4. The receiver of claim 3 wherein said display unit displays text corresponding to at least one of said program type identifiers and identifies whether said at least one of said program type identifiers is invalid.

5. The receiver of claim 1 further comprising a program search processing unit in communication with said receiving unit and operable to identify program information segments with one or more program type identifiers that correspond to one or more program type identifiers selected by a user.

6. The receiver of claim 5 wherein said one or more program type identifiers comprises a first program type identifier and a second program type identifier, said first program type identifier provided by a program provider and said second program type identifier optionally added by a user.

7. A receiver comprising:
a receiving unit operable to receive a plurality of program information segments, each of said plurality of program information segments being associated with a plurality of program type identifiers;
a program type information editing unit in communication with said receiving unit and operable to designate at least one of said plurality of program type identifiers valid; and
an editing result storage unit in communication with said receiving unit and operable to identify program type identifiers that have been designated valid by said program type information editing unit.

8. The receiver of claim 7 wherein said receiving unit comprises:
an antenna;
a front end unit in communication with said antenna;
a signal demodulator in communication with said front end unit;
a program selector in communication with said signal demodulator;
an audio decoder in communication with said program selector;
a digital to audio converter in communication with said audio decoder;
an amplifier in communication with said digital to audio converter; and
a speaker in communication with said amplifier.

9. The receiver of claim 7 further comprising:
a display unit in communication with said receiving unit and operable to display said at least one of said program type identifiers; and
an operating unit in communication with said receiving unit and operable to select program type identifiers displayed by said display unit,
wherein said program type information editing unit designates the program type identifier selected by said operating unit valid.

10. The receiver of claim 9 wherein said display unit displays text corresponding to at least one of said program type identifiers and identifies whether said at least one of said program type identifiers is valid.

11. The receiver of claim 10 further comprising a program search processing unit in communication with said receiving unit and operable to identify program information segments with one or more program type identifiers that correspond to one or more program type identifiers selected by a user.

12. The receiver of claim 11 wherein said one or more program type identifiers comprises a first program type identifier and a second program type identifier, said first program type identifier provided by a program provider and said second program type identifier optionally added by a user.

13. A receiver comprising:
a receiving unit operable to receive a plurality of program information segments, each of said plurality of program information segments being associated with a plurality of program type identifiers;
a program type information editing unit in communication with said receiving unit and operable to associate a program type validity designation with one or more of said plurality of program type identifiers for said plurality of program information segments;
an editing result storage unit in communication with said program type information editing unit and operable to store data created by said program type editing information unit;
a display unit in communication with said program type information editing unit and operable to display information corresponding to one or more of said plurality of program type identifiers;
an operating unit in communication with said program type information editing unit and operable to allow a user of said receiver to select one or more of said program type identifiers the corresponding information of which is displayed by said display unit; and
a program search processing unit in communication with said program type editing unit and operable to select program information segments utilizing said program type validity designations.

14. A receiver according to claim 13, wherein said receiving unit is a digital broadcast receiving unit.

15. A program search method, said program search method comprising the acts of:
receiving a plurality of program information segments, each of said program information segments being associated with a plurality of program type identifiers;
associating a program type validity designation with at least one of said program type identifiers; and
storing results of said act of associating a program type validity designation with at least one of said program type identifiers.

16. The program search method of claim 15 wherein said program type validity designation comprises a data string corresponding to a valid identification.

17. The program search method of claim 15 wherein said program type validity designation comprises a data string corresponding to an invalid identification.

18. The program search method of claim 15 further comprising the acts of:
displaying information corresponding to at least one of said plurality of program type identifiers for said plurality of program information segments; and
selecting at least one of said plurality of program type identifiers.

19. The program search method of claim 18 further comprising the act of distinguishing program identifiers according to a program type validity designations.

20. The program search method of claim 15 further comprising the act of selecting a subset of program information segments utilizing said program type identifiers and said program type validity designations.

21. The program search method of claim 15 wherein said plurality of program type identifiers comprise a plurality of first program type identifiers and a plurality of second program type identifiers, said plurality of first program type identifiers being provided by a program provider and said plurality of second program type identifiers being optionally provided by a user.

22. The program search method of claim 15 further comprising the act of initially setting all program type validity designations to identify all program type identifiers to be valid.

23. The program search method of claim 16 further comprising the act of initially setting all program type validity designations to identify all program type identifiers to be invalid.
